(19) United States
(12) Patent Application Publication
(10) Pub. No.: US 2007/0121757 A1
(43) Pub. Date: May 31, 2007

(54) Calibration apparatus and method for quadrature modulation system

(76) Inventors: Lichung Chu, San Diego, CA (US); Kiyoyuki Ihara, San Diego, CA (US); Kenji Kamitani, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/289,072

(22) Filed: Nov. 29, 2005

(51) Int. Cl. H04L 25/03

(52) U.S. Cl. 375/296

(57) ABSTRACT

A calibration apparatus for a quadrature modulation system with a quadrature modulation compensator and a logarithmic envelop detector, wherein a parameter update of the quadrature modulation compensator is derived by utilizing a transformed offset value and a transformed gain value of the logarithmic envelop detector as intermediate parameters, and the transformed offset and the transformed gain parameters are used in a training sequence of the quadrature modulation compensator.

### BACKGROUND OF THE INVENTION

1. Field of the Invention

This invention relates to a calibration apparatus and method for a quadrature modulation system, and more particularly to a digital-signal-processing based calibration apparatus with logarithmic envelope detectors, the apparatus and method being suitable for correcting imperfections in an analog quadrature modulator normally found in transmitters of communication systems.

2. Description of the Related Art

As shown in FIG. 1, prevalent in the transmitters of communication systems, a quadrature modulator (QM) upconverts a complex baseband signal IQ to sine and cosine waveforms at intermediate or carrier frequency. As in most analog circuitry, the QM has non-idealities such as DC offset, gain imbalance, and phase imbalance between the I and Q channels. These non-idealities, referred to as IQ imbalance, result in imperfect transmitted signals having increased Error Vector Magnitude (EVM) and decreased Adjacent Channel Power Ratio (ACPR).

To reduce these problems, a variety of calibration schemes have been proposed. Some of these schemes apply training signals to the quadrature modulation system (called TSM herein) and some do not (called NTSM herein). In the article by T. Louie Valena, “System Design of Modem IC for Wireless LAN: Compensation Algorithm for Impairment of Orthogonal Modulator”, Design Wave Magazine, December 2003 (Valena), a calibration system without training signals is described. The approach, however, cannot apply directly to a system that takes advantage of training signals to reduce computational cost. Furthermore, Valena also has poor performance in modulation schemes with little amplitude or phase variation.

Another class of calibration techniques uses training signals to apply a known input to a system and measure QM output with an envelope detector (ED). In practice, an ED specification provides its gain in the form of the slope of output vs. input curves, such as that shown in FIG. 3. Also, the offset may be roughly estimated from the curve as the output for 0 dBm input. However, the actual gain and offset can drift over time. Therefore, a calibration method that factors in the uncertainty of the ED gain and offset is of interest. Furthermore, inside most ED's are diodes, whose response curves are logarithmic due to their physical characteristics. ED's with logarithmic characteristics are easier to make and are more popular in industry.

U.S. Pat. No. 5,293,406 discloses a QMC with TSM. The problems of drifting ED gain and offset are considered for square-law ED's. Besides, U.S. Pat. No. 5,293,406 does not teach compensation for the drift of ED gain and offset. Furthermore, the method of U.S. Pat. No. 5,293,406 requires many changes of amplitude and phase in the testing sequence, and therefore has high computational cost.

Two methods are proposed by J. K. Cavers in “New Methods for Adaptation of Quadrature Modulators and Demodulators in Amplifier Linearization Circuits,” IEEE Trans. on Vehicular Technology, vol. 46, no. 3, Aug. 1997, pp. 707-716, (Cavers) which is incorporated herein by reference in its entirety. One of these methods uses a set of training signals (TSM), and the other does not. As with Valena, mentioned above, the Cavers method without training signals (NTSM) performs poorly for modulation schemes with little variation in amplitude and angles. The system also has singularity problems. For both methods, compensation procedures for systems only with linear ED's are provided.

The calibration method with training signals can be performed either before QM starts normal transmission or between transmissions in systems such as a packet-switched system or a time division multiplexed system. Because the method incurs less computational cost, it takes less power and is more suitable for portable devices.

A QM with TSM and calibration circuitry as set forth in Cavers is shown in FIG. 2. In the feedback loop, an Envelope Detector (ED) is used to measure the QM output corresponding to a set of predefined training signals. The ED outputs are used by the calibration circuit to adjust a QM compensator (QMC), which compensates for QM non-idealities. The predistortion block (PD) used to compensate for the nonlinearity of the power amplifier (PA) is also depicted.

However, the calibration procedure discussed in Cavers for a linear ED does not apply to circuitry equipped with logarithmic ED's. Because of the logarithmic mathematics, the methodology of linear approximation applied in Cavers does not result in a system of linear equations accurately modeling the ED gain, ED offset, QM offset, and QM phase/gain imbalance for the nonlinear system with logarithmic ED's. Solving nonlinear equations, however, requires numerical calculation methods, which might involve complicating issues such as stability, solvability, and convergence rate.

### SUMMARY OF THE INVENTION

Accordingly, it is an object of the present invention to provide a calibration algorithm that is effective in achieving robust performance with low computational cost and fast convergence rate.

In one embodiment, a calibration apparatus for a quadrature modulation system comprises a logarithmic envelop detector, a quadrature modulation compensator configured to compensate non-idealities in the system based at least in part on compensation parameters, and

a calibration circuit configured to calculate compensation parameters based at least in part on one or more intermediate parameters defined by linear functions of gain and offset parameters of the logarithmic envelope detector.

In another embodiment, a method of calibrating a quadrature modulation system comprising a quadrature modulation compensator and a logarithmic envelop detector is provided. In this embodiment, the method comprises calculating a transformed offset of the envelop detector based at least in part on a first system output in response to a first training signal applied to the quadrature modulation compensator and calculating a transformed gain of the envelop detector based at least in part on the transformed offset and a second system output in response to a second training signal applied to the quadrature modulation compensator. A set of compensation parameters based at least in part on the transformed gain is calculated, and the performance of the quadrature modulation compensator is adjusted based at least in part on the compensation parameters.

In another embodiment, a method of calibrating a quadrature modulation system comprising a quadrature modulation compensator and a logarithmic envelop detector comprises

applying a first training signal having N phases to the quadrature modulation compensator and

calculating a first value based at least in part on a system output comprising a response to each of the phases in the first training signal. The first transformed offset \hat{d} is found by the following:

$$\hat{d} = \frac{1}{N} {\sum }_{n = 1}^{N} {\underline{m}}_{1} ( n ) ,$$

wherein m₁ (n) is the system output response to the n^{th} phase, and using \hat{d} in a computation of compensation parameters used for calibrating the quadrature modulation system.

In some embodiments, this method further includes storing \hat{d}, and applying additional K−1 training signals to the quadrature modulation compensator, wherein each of the K training signals has N phases and a different amplitude V_{dk}. A second value based at least in part on a system output in response to the K training signals, is found by the following:

$$\hat{g} = \frac{{\sum }_{k = 1}^{K} \{ ( {\tilde{\underline{m}}}_{k}^{T} \underline{1} ) log ( {V}_{dk} ) \}}{N {\sum }_{k = 1}^{K} \{ {log ( {V}_{dk} )}^{2} \}} ,$$

wherein \tilde{m}ₖ=mₖ−\hat{d}1, and mₖ is a vector of system output corresponding to the k^{th} training signal.

In further embodiments, this method further comprises calculating a first error vector based at least in part on the second value, wherein the first error vector \hat{q} is found by the following:

$$\underline{\hat{q}} = \frac{2}{N \hat{g}} {( {\sum }_{k = 1}^{K} {S}_{k}^{2} )}^{- 1} ( {\sum }_{k = 1}^{K} {Ω}_{k} ) ,$$

wherein Ωₖ=SₖΘ^{T} \tilde{m}ₖ, Sₖ is a 4×4 matrix, diag(0.5,0.5 1/V_{dk}, 1/V_{dk}) and Θ is an N×4 matrix, whose n^{th} row is [cos(2θₙ), sin(2θₙ), cos(θₙ), sin(θₙ)].

### BRIEF DESCRIPTION OF THE DRAWINGS

FIG. 1 is a circuit diagram showing a conventional QM.

FIG. 2 is a circuit diagram showing a QM with calibration circuitry of Cavers.

FIG. 3 is a characteristic graph showing an example of output vs. input for a logarithmic ED.

FIG. 4 is a circuit diagram showing a QMC subsystem with compensation carried out in the digital domain.

FIG. 5 is a circuit diagram showing a QMC subsystem with compensation carried out in the analog domain.

FIG. 6 is a diagram showing a constellation for a set of training signals on the I/Q plane.

FIG. 7 is a diagram showing an internal structure of the QMC and QM cascade constellation.

FIG. 8 is a flow chart showing a calibration procedure of QMC shown in FIG. 2.

FIG. 9 is a table comparing computational cost per iteration of various calibration procedures.

FIG. 10 is a graph showing the response curve of AD8364 at 2.5 GHz.

FIG. 11 is a plot showing I/Q values at QM output (solid line: without compensation; dotted line: after compensation).

FIG. 12 is a graph showing the error versus the number of iterations executed.

FIG. 13 is a graph showing the mean and two times standard deviation of the number of iterations as a function of the number of test phases used (N) in each ring regarding to the example 2.

FIG. 14 is a characteristic chart showing the relative computational cost as a function of N for one example.

### DESCRIPTION OF CERTAIN EMBODIMENTS

Embodiments of the present invention will be described in detail below with reference to the accompanying drawings. Note that the present invention is not limited to the following embodiments and can be modified as required.

System Architecture

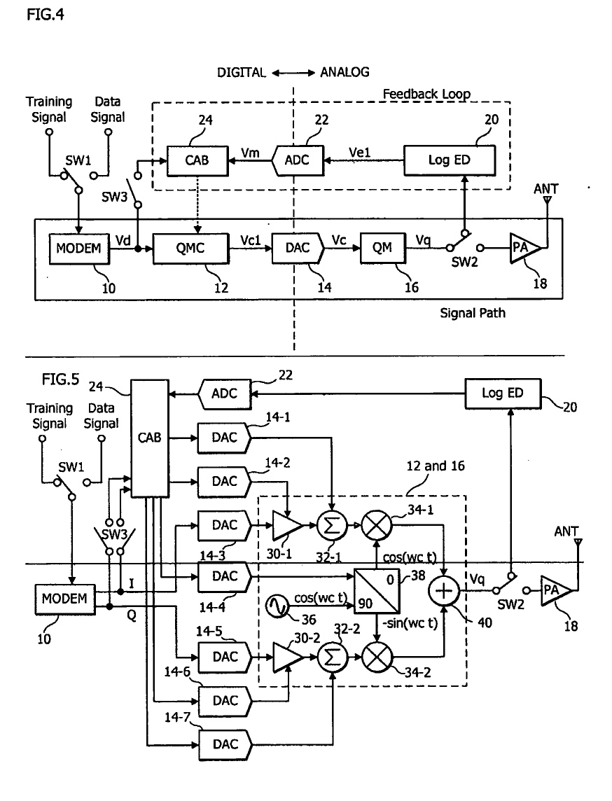

FIG. 4 is a circuit diagram showing an example of a QMC subsystem with compensation carried out in the digital domain. As shown in this figure, this subsystem embodiment example comprises a signal path and a feedback loop. The signal path comprises a MODEM 10 configured to execute complex modulation of a training signal or a data signal to generate a baseband signal, a QMC 12 configured to compensate IQ imbalance of a QM 16, a DAC 14 configured to convert a set of digital IQ signals Vc1 to a set of analog IQ signals Vc, a QM 16 configured to convert the baseband signal Vc to a RF signal Vq as shown in FIG. 1, and a PA 18 configured to drive an antenna ANT to transmit the signal.

The feedback loop comprises a logarithmic ED 20 configured to detect an output level of the QM 16 in accordance with the logarithmic characteristic of the logarithmic ED 20, an ADC 22 configured to convert an analog ED signal Ve1 to a digital ED signal Vm, and calibration circuitry 24 used to calibrate the QMC 12 in order to adjust the IQ balance of the QM 16.

In this embodiment, when the calibrations are executed the SW1 is set to the training signal side, the SW2 is set to the ED side, and the switch SW3 is closed. A set of training signals are input to the digital modem 10 and the modem 10 sends the complex training signals to the QM 16 through the QMC 12. The combined QMC 12 and QM 16 response is measured at the output of the logarithmic ED 20. The calibration circuitry 24 takes the measurements, computes the appropriate compensation parameters for the QMC 12, and provides the compensation parameters to the QMC 12 before the next set of training signals is sent. Ideally, the QMC 12 after receiving the compensation parameters will be an inverse function of the QM 16, such that the output of the QM 16 equals that of the modem 10.

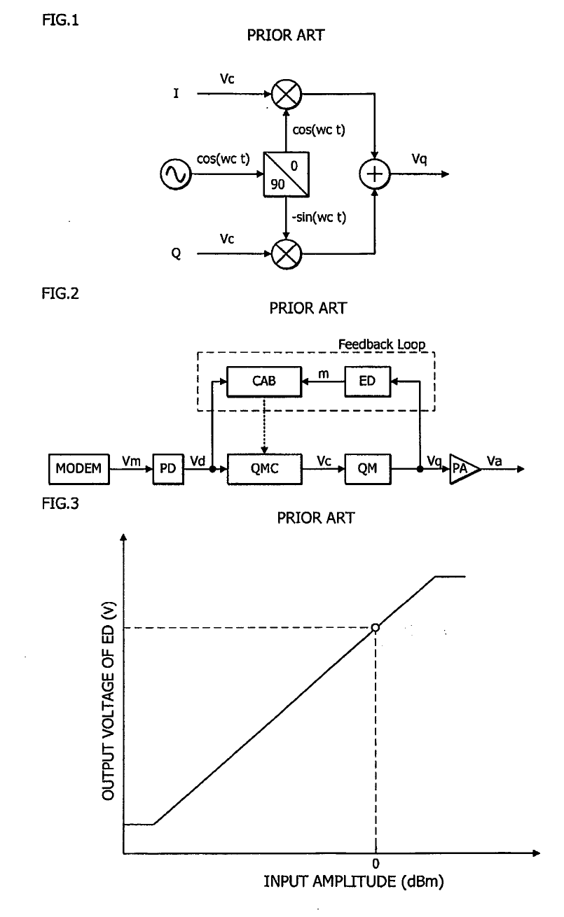

FIG. 5 is a circuit diagram showing an example of a QMC subsystem with compensation carried out in the analog domain. As shown in this figure, this subsystem comprises a signal path and a feedback loop similar to the QMC subsystem shown in FIG. 2. The signal path comprises a MODEM 10 configured to execute complex modulation of a training signal or a data signal to generate a baseband signal, DACs 14-3 and 14-5 configured to convert a set of digital IQ signals to a set of analog IQ signals, a QMC 12 and a QM 16 configured to upconvert the baseband signal to an RF signal with compensated IQ imbalance, and a PA 18 configured to amplify the RF signal to transmit with an antenna ANT.

The feedback loop comprises a logarithmic ED 20 configured to detect an output level of the QM 16 in accordance with the logarithmic characteristic of the logarithmic ED, an ADC 22 configured to convert an analog ED signal to a digital ED signal, calibration circuitry 24 used to calibrate the QMC 12 in order to adjust the IQ balance of the QM 16, DACs 14-1 and 14-2 configured to send analog compensation parameters to the QMC 12 of the I channel, DACs 14-6 and 14-7 configured to send analog compensation parameters to the QMC 12 of the Q channel, and a DAC 14-4 configured to send analog compensation parameters for the phase compensation.

The QMC 12 comprises gain compensators 30-1 and 30-2 configured to adjust the IQ gain balance of the QM 16, and offset compensators 32-1 and 32-2 configured to adjust the offset of the QM 16.

The QM 16 comprises a frequency synthesizer 36 configured to set a carrier wave of cos(ω_{c}t), a variable phase shifter 38 configured to generate an in-phase carrier of cos(ω_{c}t) and a quadrature carrier of −sin(ω_{c}t), mixers 34-1 and 34-2 configured to mix the IQ carriers and the IQ signals, and a combiner 40 to combine the in-phase RF signal and the quadrature RF signal.

In this embodiment, the compensation parameters of the QM 12 calculated by the calibration circuitry 24 are transferred via control signals to the analog circuitry. According to the control signals, the analog circuitry adjusts its tunable components such as gain stages 30-1 and 30-2, and offset controllers 32-1 and 32-2, to modify the signal before it is sent to the QM 16, where it is phase adjusted by the variable phase shifter 38 according to the control signals. Other operations may be similar to that of the QMC subsystem shown in FIG. 2 and/or FIG. 4.

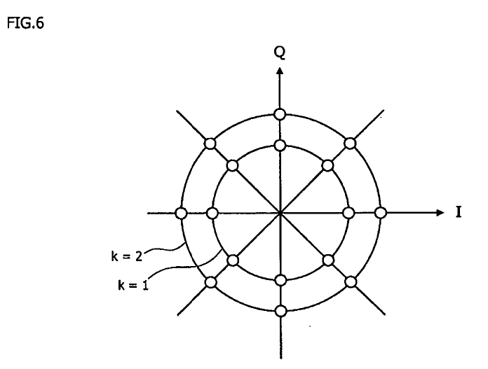

FIG. 6 is a diagram showing a constellation in the I/Q plane for a set of training signals. The complex-valued training signals are located on K rings of various amplitudes (K=2 in this figure). The points on each ring are evenly distributed with phase θₙ(n=1, . . . , N). The integer N is selected as a power of 2.

Modeling of QM and QMC

The non-idealities of the QM include I/Q offset cₚ=[cₚ₁ cₚ₂]^{T}, gain imbalance αₚ/βₚ, and phase imbalance φₚ.

As shown in FIG. 4, as a length-2 vector v_{c1}, whose first and second elements are the real and imaginary components respectively, denotes the complex envelope at the QM input. The corresponding envelope at the QM output is denoted by v_{q}. The complex envelope response of the QM may be expressed as
v_{q}=GₚΦₚ(v_{c}+cₚ), (1)
where Gₚ is a 2×2 matrix for the gain imbalance,

$${G}_{p} = [ \begin{matrix}{α}_{p} & 0 \\ 0 & {β}_{p}\end{matrix} ] ,$$

Φₚ is a 2×2 matrix for the phase imbalance,

$${Φ}_{p} = [ \begin{matrix}cos ( \frac{{ϕ}_{p}}{2} ) & sin ( \frac{{ϕ}_{p}}{2} ) \\ sin ( \frac{{ϕ}_{p}}{2} ) & cos ( \frac{{ϕ}_{p}}{2} )\end{matrix} ] ,$$

and cₚ=[cₚ₁ cₚ₂]^{T} is a length-2 vector of I/Q offset.

Similarly, we can express the complex-envelope response of the QMC as

$${v}_{c} = {Φ}_{c} {G}_{c} {v}_{d} + {c}_{c} , \\ where \\ {G}_{c} = [ \begin{matrix}{α}_{c} & 0 \\ 0 & {β}_{c}\end{matrix} ] , \\ {Φ}_{c} = [ \begin{matrix}cos ( \frac{{ϕ}_{c}}{2} ) & sin ( \frac{{ϕ}_{c}}{2} ) \\ sin ( \frac{{ϕ}_{c}}{2} ) & cos ( \frac{{ϕ}_{c}}{2} )\end{matrix} ] , and \\ {c}_{c} = {[ {c}_{c 1} {c}_{c 2} ]}^{T} . \qquad ( 2 )$$

The total response of the cascaded QMC and QM is given by substituting v_{c} in Equation (1) by that in Equation (2),
v_{q}=GₚΦₚΦ_{c}G_{c}v_{d}+GₚΦₚ(c_{c}+cₚ).

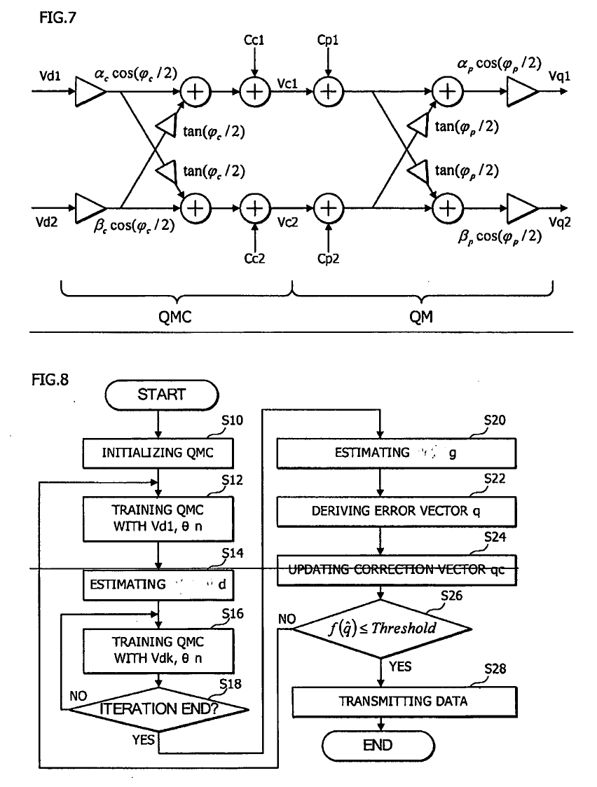

FIG. 7 is a diagram showing an analytical structure of the QMC cascaded with the QM. The error vector qₚ is defined by [εₚ φₚ cₚ₁ cₚ₂]^{T}, where the relationships between εₚ, and αₚ and βₚ are given by

$${α}_{p} = ( 1 + {ɛ}_{p} ) \sqrt{\frac{2}{2 + 2 {ɛ}_{p} + {ɛ}_{p}^{2}}} , and$$

$${β}_{p} = \sqrt{\frac{2}{2 + 2 {ɛ}_{p} + {ɛ}_{p}^{2}}} .$$

Another vector q is defined as the total error generated by the cascaded QMC and QM. The vector q can be linearly approximated by the sum of qₚ and q_{c}, i.e., q≈q_{c}+qₚ.

Modeling of ED

The output of the logarithmic ED may be expressed by a real value Vₑ₁,
vₑ₁=g_{ED}log(vₑ)+d_{ED}, (3)
where vₑ is the ideal ED output that reflects the actual envelope of the sinusoidal waveforms. The g_{ED} and d_{ED} denote the actual value of the ED's gain and offset, respectively. Hence the measurement at output of ADC is given by
vₘ=vₑ₁+n,
where n is a uniformly distributed random variable to model the quantization noise of the ADC.

The measurements corresponding to each set of training signals can be represented by a vector, denoted by m.

Finally, to help explain the materials in the remainder of the discussion, the following two variables are also defined,
ĝ=ƒ₁(g_{ED},d_{ED}),
and
\hat{d}=ƒ₂(g_{ED},d_{ED}),
where ƒ₁(x) and ƒ₂(x) are linear functions. Definition of these two functions, however, is not needed to execute the calibration procedure of this invention. This point will be elaborated later in the examples.
Calibration Strategy

The actual gain and offset of the ED are assumed unknown a-priori. They are also not necessarily calculated, but the parameters transformed gain and transformed offset, which are related to the actual gain and offset by a mathematical transformation, are jointly estimated with q by the calibration circuitry. The circuitry estimates the six parameters ĝ,\hat{d}, and the q parameters εₚ, φₚ, cₚ₁, and cₚ₂ based on least-squared fit of the measurement m with reference to the linear approximation of the desired output, i.e.,

$$( \underline{\hat{q}} , \hat{g} , \hat{d} ) = {arg}_{ \underline{q} , g , d} min \{ {\sum }_{k = 1}^{K} {‖ {\underline{m}}_{k} - g Θ {S}_{k} \underline{q} - ( g log ( {V}_{dk} ) + d ) \underline{1} ‖}^{2} \} , \qquad ( 4 )$$

where mₖ is the vector of measurements for training signals of magnitude corresponding to the k^{th} ring. Sₖ is a 4×4 matrix, diag(0.5,0.5, 1/V_{dk}, 1/V_{dk}), where v_{dk} is the amplitude of the k^{th} ring. Θ is an N×4 matrix, whose n^{th} row is [cos(2θₙ), sin(2θₙ), cos(θₙ), sin(θₙ)].

The values of interest of the six parameters ĝ,\hat{d}, and the \hat{q} parameters εₚ, φₚ, cₚ₁, and cₚ₂ are those which minimize the error and therefore minimize the expression E, which is defined as the terms inside min{●} in Equation (4). Since E is a convex function of the parameters, setting the partial derivatives of E with respect to each of ĝ, \hat{d}, and \hat{q} equal to zero will result in criteria for obtaining the correct parameter values to adjust the QMC. These criteria, ∂E/∂\hat{q}=0, and ∂E/∂d=0, are used to derive a set of relationships between the measurement m and variables to be estimated, \hat{d}, ĝ, and \hat{q}. Because the function of Equation (4) is a nonlinear function of the variables, \hat{d}, ĝ, and \hat{q}, the task is non-trivial. The resulting set of relationships, described below, facilitate a straightforward procedure to sequentially solve for the variables \hat{d}, ĝ, and \hat{q}.

Calibration Procedure

The one variable at a time approach is reminiscent of the Gaussian elimination method used to solve a system of linear equations. As the calibration procedure is based on linear approximation of the QM and the QMC errors, a few iterations are expected for the algorithm to converge.

FIG. 8 is a flow chart showing a calibration procedure for a QMC such as that shown in FIG. 4. As shown in FIG. 8, this calibration procedure is performed by the following steps.

At the step S10, the switch SW1 is flipped at the modem 10 input to ‘Training Signal’. The switch SW2 is flipped to the ED input. The switch SW3 is closed, and the QMC parameters are initialized with ε_{c}=φ_{c}=0, and c_{c}=0.

At the step S12, The QMC is updated with parameters ε_{c}, φ_{c} and c. A QMC input vector of n training signals with amplitude V_{d1} and n phases θₙ, n=1, . . . N, evenly distributed from 0 to 2π is applied. The amplitude V_{d1} should be selected so as to keep the ED in its linear region of operation, but need not be at 0 dBm. Selection of the number of phases N is a system design choice. In some embodiments N is a power of two between 8 and 64. The measurements, denoted by a vector m₁, are taken at the ADC 22 output. The measurements collected in the step S12 may be reused in the following steps to reduce measurement time.

At the step S14, a first intermediate parameter \hat{d} is calculated with Equation 5 below. This parameter is sometimes referred to herein as a transformed ED offset parameter. This parameter is given by the mean of the elements in m₁,

$$\hat{d} = \frac{1}{N} {\sum }_{n = 1}^{N} {\underline{m}}_{1} ( n ) \qquad ( 5 )$$

At the step S16, another set of training signals is applied with the same set of phases θₙ, n=1, . . . N, but with a different amplitude V_{d2}. The corresponding measurements are denoted by m₂. If more iterations are desired at step S18, Step S16 is repeated for various amplitudes V_{dk} for k=2,3, . . . K, according to the number of iterations desired.

At the step S20, a second intermediate parameter ĝ is computed. This is sometimes referred to herein as the transformed ED gain. A value for the parameter ĝ is obtained by

$$\hat{g} = \frac{{\sum }_{k = 1}^{K} \{ ( {\tilde{\underline{m}}}_{k}^{T} \underline{1} ) log ( {V}_{dk} ) \}}{N {\sum }_{k = 1}^{K} \{ {log ( {V}_{dk} )}^{2} \}} , \\ where \\ {\underline{\tilde{m}}}_{k} ≡ {\underline{m}}_{k} - \hat{d} \underline{1} , \qquad ( 6 )$$

with \hat{d} obtained in step S14.

At the step S22, the overall error vector is estimated. The error vector is calculated by substituting ĝ and \tilde{m}ₖ in Step S20 into the following equation,

$$\underline{\hat{q}} = \frac{2}{N \hat{g}} {( {\sum }_{k = 1}^{K} {S}_{k}^{2} )}^{- 1} ( {\sum }_{k = 1}^{K} {Ω}_{k} ) , \\ where$$

$${Ω}_{k} ≡ {S}_{k} {Θ}^{T} {\underline{\tilde{m}}}_{k} .$$

At the step S24, the compensation vector q_{c}(l+1)=q_{c}(l)−\hat{q} is updated. With the new value of q_{c}=[ε_{c} φ_{c} c_{c1} c_{c2]}^{T}, the corresponding matrices/vectors for QMC are also updated, resulting in

$${G}_{c} = [ \begin{matrix}( 1 + {ɛ}_{c} ) \sqrt{\frac{2}{2 + 2 {ɛ}_{c} + {ɛ}_{c}^{2}}} & 0 \\ 0 & \sqrt{\frac{2}{2 + 2 {ɛ}_{c} + {ɛ}_{c}^{2}}}\end{matrix} ] , \\ {Φ}_{c} = [ \begin{matrix}cos ( \frac{{ϕ}_{c}}{2} ) & sin ( \frac{{ϕ}_{c}}{2} ) \\ sin ( \frac{{ϕ}_{c}}{2} ) & cos ( \frac{{ϕ}_{c}}{2} )\end{matrix} ] , and$$

$${c}_{c} = {[ {c}_{c 1} {c}_{c 2} ]}^{T} .$$

At the step S26, the termination criterion ƒ(\hat{q})≦Threshold is checked. If true, go to the step S28. If not, go back to the step S12.

At the step S28, the switch SW1 at the modem 10 input is flipped to ‘Data Signal’. The switch SW2 is flipped to the PA 18 input. The switch SW3 is opened. Then, transmitting the regular data is started.

The above mentioned procedure is performed with the following assumptions:

(1) Neither QM nor QMC alters the signal power. That is, αₚ²+βₚ²=α_{c}²=β_{c}²=2.

(2) The quantization noise of the DAC is significantly less than that of the ADC. Therefore, quantization noise of the DAC may be ignored.

(3) The actual values of g and d do not vary during the period when the training signals are applied.

It is also noted that the functions ƒ₁ and ƒ₂ are non-trivial if the amplitude V_{d1}, of the training signals used to estimate \hat{d} is not equal to 1. In other words, the transformed ED gain and offset will not be the actual ED gain and offset, but rather the transformed ED gain and offset will, instead be mathematical transformations of the actual ED gain and offset. However, the difference between the estimated and the actual ED gain and offset will not corrupt the calibration results of the procedure because the values of ĝ and \hat{d} are used as intermediate results for calculating the error vector q. With the method described below, q converges to the correct value despite ĝ and \hat{d} being transformations of the actual gain and offset.

This point will be revisited in the examples.

Computational Complexity

Computational complexity is analyzed for computing estimates of the variables:
(1) Compute \hat{d}: N sums and one division. This division can be replaced by bit-shifts since N is a power of 2.
(2) Compute ĝ: Since

$$( {\underline{\tilde{m}}}_{k}^{T} \underline{1} ) = ( {\sum }_{n = 1}^{N} {m}_{n , k} ) - N * {\hat{d}}_{ED} ,$$

the computational cost is (N+1) sums and one product for each k. The product here can be replaced by bit-shifts. The calculation of {(\tilde{m}ₘₖ^{T}1)log(V_{dk})} takes one product of (\tilde{m}ₖ^{T}1) with the constant {log(V_{dk})}, which may be pre-stored in a lookup table. The constant

$$\frac{1}{N} {\sum }_{k = 1}^{K} \{ {log ( {V}_{dk} )}^{2} \}$$

can also be pre-stored in a lookup table, and thus the division can be replaced by a product. In summary, it takes K(N+1) sums and (K+1) products.
(3) Compute q: For each k, Ωₖ≡SₖΘ^{T}\tilde{m}ₖ requires 4N multiply-and-sum since SₖΘ^{T} may be pre-calculated and store in a lookup table. The term

$$\frac{2}{N} {( {\sum }_{k = 1}^{K} {S}_{k}^{2} )}^{- 1}$$

may be pre-calculated, and

$$\frac{1}{\hat{g}}$$

requires one division.

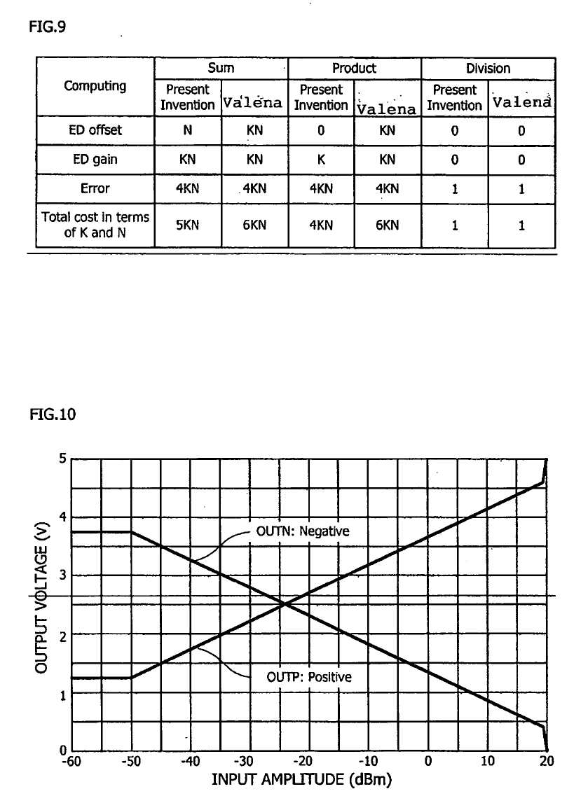

In summary, the approximate computational cost for a single iteration is listed in FIG. 9. The computational cost of using the method of Valena is also shown in FIG. 9. To facilitate fair comparison, two approaches are applied to both methods. First, the terms in the estimation equations are re-arranged and merged wherever possible to reduce computational complexity. Secondly, all constants that do not need to be calculated in real time are assumed to be pre-stored in memory. The cost saved per iteration by the embodiment described above compared to Valena, is on the order of KN sums and 2KN products. The actual system savings depends on the number of iterations and on how often the calibration is needed. In many systems the computational savings of KN sums and 2KN products per iteration is significant.

Two example embodiments are provided to help illustrate the method.

### EXAMPLE 1

The ED and ADC selected here for this embodiment are Analog Devices AD8364 and AD7655 (16-bit), respectively. FIG. 10 provides the response curve of AD8364 at 2.5 GHz. For the purpose of example, we may roughly estimate the actual ED gain and offset from FIG. 10 by measuring the slope of the linear section and its crossing point at 0 dBm input, respectively,

$${g}_{ED} ≅ \frac{3.5 - 2}{- 5 - ( - 35 )} = 0.05$$

$${d}_{ED} ≅ 3.7$$

Using the dBm unit for input, a suitable amplitude v_{ref} to estimate the ED offset d should satisfy

$$log \frac{{v}_{ref}^{2}}{{10}^{- 3}} = 0.$$

Let us define the desired operating amplitude to be vₒₚ=a*v_{ref}, where a≠1. Then the ED output without noise is given by

$$\begin{matrix}{v}_{e 1} = {g}_{ED} log ( \frac{{a}^{2} {v}_{ref}^{2}}{{10}^{- 3}} ) + {d}_{ED} \\ = ( 20 * {g}_{ED} ) log {v}_{op} + ( 30 * {g}_{ED} + {d}_{ED} )\end{matrix} \qquad ( 7 )$$

The second expression above is obtained by algebraically manipulating terms and substituting a*v_{ref} with vₒₚ. Comparing Equation (7) with Equation (3), we see that the ED gain and offset estimated by the proposed procedure are
g=ƒ₁(g_{ED})=20*g_{ED}
d=ƒ₂(g_{ED},d_{ED})≡30*g_{ED}+d_{ED} (8)
which are functions of the actual ED gain and offset, instead of the values themselves. However, the difference between the estimated and the actual ED gain and offset will not affect the calibration results of the procedure because the estimates of g and d are used as intermediate results for calculating the error vector q.

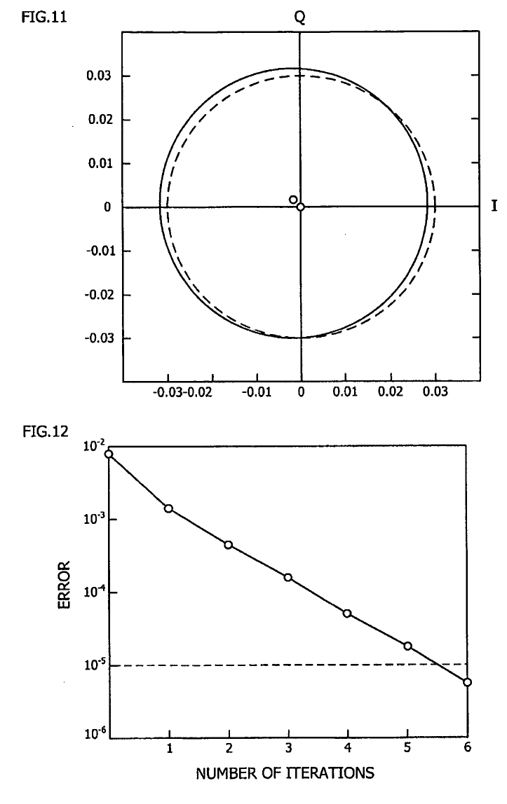

The output at the OUTP port of AD8364 is in the range of 1 to 5 volt, which is suitable for AD7655 input. The step size of AD7655 with operation range of 0 to 5 volt is Δ=5/2¹⁶=7.63*10⁻⁵. In the following experiment, the ADC quantization error is modeled as a noise with uniform distribution, n˜U(−Δ/2,Δ/2). The QMC non-idealities are summarized below,
εₚ=−0.05
φₚ=5°
cₚ₁=cₚ₂=5%
The Threshold used in this example is 10⁻⁵. For training signals, the number of test points per ring is 16 (N=6) and two rings (K=2) are applied in FIG. 11 and FIG. 12.

FIG. 11 shows a locus for each of a set of test signals, the QM output without compensation by the QMC, and the QM output with compensation by the QMC with parameters calculated by the procedure described above. The solid line depicts he QM output without compensation by the QMC. The dashed line depicts the set of test signals, also representing the desired output with system non-idealities compensated for. Because at this scale they are indistinguishable, the dashed line also represents the QM output with compensation by the QMC with parameters calculated by the procedure described above.

FIG. 12 shows that the error decreases as the number of iterations increases. This allows for design tradeoff decisions between number of iterations and error. In this example, the number of iterations to achieve error less than 10⁻⁵ is 6. Additionally, the number of iterations stays at 6 for N=4,8,16,32,64. Therefore, N=4 is enough for this example.

### EXAMPLE 2

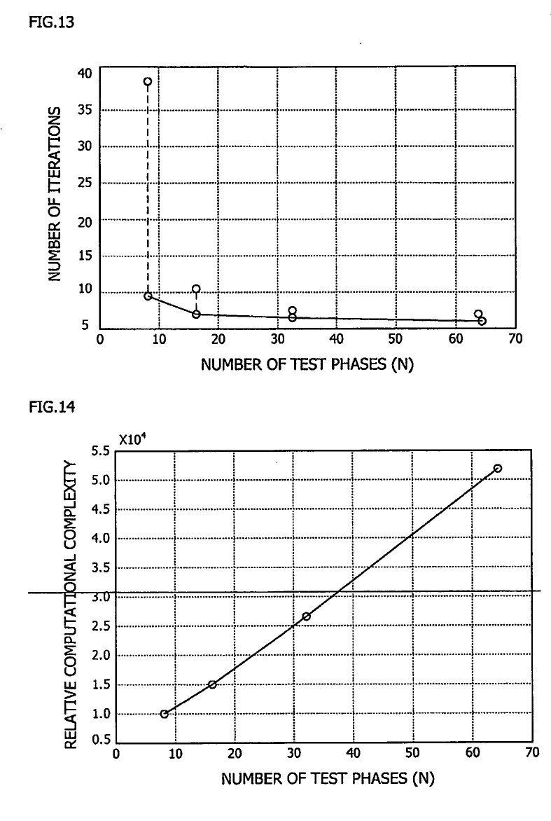

To demonstrate the robustness of the method, the simulation setup of this example is the same as that used in example 1, except that an 8-bit ADC, such as AD7904, is used in this example instead of the 16-bit ADC used in example 1. The noise introduced by quantization error is larger, and is reflected in the variation of the number of iterations needed from trial to trial. Where 200 trials were performed for each N, the mean and 2σ values (where σ is standard deviation) of the number of iterations needed are illustrated in FIG. 13.

The performance is manageable because the mean and standard deviation decrease and the computational cost per iteration increases with N. Relative computational cost for each N is shown in FIG. 14. Without losing the relative sense of computational cost for various values of N, the cost of bit-shifts and division are not counted. The complexity ratio between addition and product is reflected assuming 16-bit fixed-point computation. The results shown in FIG. 13 and FIG. 14 suggest that a good choice of N may be 16, which has a more consistent performance (a is small) with only a modest increase in computational cost.

According to the presented embodiments, a simple procedure is provided for correcting the amplitude, phase, and offset non-idealities of the quadrature modulator in transmitter circuitry. The performance is manageable with modest computational cost.

While the above description has pointed out novel features of the invention as applied to various embodiments, the skilled person will understand that various omissions, substitutions, and changes in the form and details of the device or method illustrated may be made without departing from the scope of the invention. All variations coming within the meaning and range of equivalency of the claims are embraced within their scope.

What is claimed is:

1. A calibration apparatus for a quadrature modulation system, the apparatus comprising:
a logarithmic envelop detector;
a quadrature modulation compensator configured to compensate non-idealities in the system based at least in part on compensation parameters; and
a calibration circuit configured to calculate compensation parameters based at least in part on one or more intermediate parameters defined by linear functions of gain and offset parameters of the logarithmic envelope detector.

2. The apparatus of claim 1, wherein the non-idealities comprise at least one of offset, gain and phase of the system.

3. The apparatus of claim 1, wherein the calibration circuit is configured to calculate the intermediate parameters based at least in part on a system output in response to one or more training signals applied to the quadrature modulation compensator.

4. The apparatus of claim 3, wherein the calibration circuit is configured to calculate a first intermediate parameter:
$$\hat{d} = \frac{1}{N} {\sum }_{n = 1}^{N} {\underline{m}}_{1} ( n ) ,$$
wherein m₁ (n) is the system output response to the n^{th} phase of a series of training signals having a first input amplitude;
wherein said calibration circuit is configured to calculate a second intermediate parameter:
$$\hat{g} = \frac{{\sum }_{k = 1}^{K} \{ ( {\underline{\tilde{m}}}_{k}^{T} \underline{1} ) log ( {V}_{dk} ) \}}{N {\sum }_{k = 1}^{K} \{ {log ( {V}_{dk} )}^{2} \}} ,$$
wherein \tilde{m}ₖ=mₖ−\hat{d}1, and mₖ is a vector of system output corresponding to the k^{th} a training signal having input amplitude different from said first input amplitude; and
wherein said calibration circuit is configured to compute a set of compensation parameters with the formula:
$$\underline{\hat{q}} = \frac{2}{N \hat{g}} {( {\sum }_{k = 1}^{K} {S}_{k}^{2} )}^{- 1} ( {\sum }_{k = 1}^{K} {Ω}_{k} ) ,$$
wherein Ωₖ=SₖΘ^{T} \tilde{m}ₖ, Sₖ is a 4×4 matrix, diag(0.5,0.5, 1/V_{dk}, 1/V_{dk}), and Θ is an N×4 matrix, whose n^{th} row is [cos(2θₙ), sin(2θₙ), cos(θₙ), sin(θₙ)].

5. The apparatus of claim 3, wherein the first training signal comprises a substantially constant input amplitude to the quadrature modulation compensator.

6. The apparatus of claim 3, wherein the calibration circuit is configured to update a set of compensation parameters based at least in part on subsequent system outputs in response to subsequent training signal inputs applied to the quadrature modulation compensator.

7. The calibration apparatus of claim 1, wherein the calibration circuit is configured to update the compensation parameters based at least in part on the following equation q_{c}(l+1)=q_{c}(l)−\hat{q}, where the error vector \hat{q} is obtained from equations derived from:
$$( \underline{\hat{q}} , \hat{g} , \hat{d} ) = {arg}_{ \underline{q} , g , d} min \{ {\sum }_{k = 1}^{K} {‖ {\underline{m}}_{k} - g Θ {S}_{k} \underline{q} - ( g log ( {V}_{dk} ) + d ) \underline{1} ‖}^{2} \} ,$$
wherein the vector mₖ is measured system output in response to a training signal applied to the quadrature modulation compensator, Sₖ being a 4×4 matrix, V_{dk} being the k^{th} amplitude, and Θ being an N×4 matrix with an n^{th} row being [cos(2θₙ), sin(2θₙ), cos(θₙ), sin(θₙ)].

8. A calibration apparatus for a quadrature modulation system comprising:
a quadrature modulator;
a quadrature modulation compensator;
a logarithmic envelop detector;
a calibration circuit;
means for applying a training signal to the quadrature modulation compensator;
means for observing an output of the system generated in response to the applied training signal;
means for calculating intermediate parameters defined as linear functions the gain and offset parameters of the envelop detector based on the output;
means for computing an error vector based at least in part on at least one of said intermediate parameters; and
means for modifying the performance of the quadrature modulation compensator based on the error vector.

9. A method of calibrating a quadrature modulation system comprising a quadrature modulation compensator and a logarithmic envelop detector, the method comprising:
calculating a transformed offset of the envelop detector based at least in part on a first system output in response to a first training signal applied to the quadrature modulation compensator;
calculating a transformed gain of the envelop detector based at least in part on said transformed offset and a second system output in response to a second training signal applied to the quadrature modulation compensator;
calculating a set of compensation parameters based at least in part on said transformed gain; and
adjusting the performance of the quadrature modulation compensator based at least in part on the compensation parameters.

10. The method of claim 9, further comprising deriving an error vector based at least in part on the transformed offset and the transformed gain.

11. The method of claim 10, further comprising adjusting the performance of the quadrature modulation compensator based at least in part on the error vector.

12. A method of calibrating a quadrature modulation system comprising a quadrature modulation compensator and a logarithmic envelop detector, the method comprising:
applying a first training signal having N phases to the quadrature modulation compensator; and
calculating a first value \hat{d} based at least in part on a system output comprising a response to each of the phases in the first training signal, wherein the first value \hat{d} is found by the following:
$$\hat{d} = \frac{1}{N} {\sum }_{n = 1}^{N} {\underline{m}}_{1} ( n ) ,$$
wherein m₁(n) is the system output response to the n^{th} phase, and
using \hat{d} in a computation of compensation parameters used for calibrating the quadrature modulation system.

13. The method of claim 12, further comprising:
storing \hat{d};
applying a first additional K−1 training signals to the quadrature modulation compensator, wherein each of the K training signals has N phases and a different amplitude V_{dk}; and
calculating a second value ĝ based at least in part on a system output in response to the K training signals, wherein the second value ĝ is found by the following:
$$\hat{g} = \frac{{\sum }_{k = 1}^{K} \{ ( {\underline{\tilde{m}}}_{k}^{T} \underline{1} ) log ( {V}_{dk} ) \}}{N {\sum }_{k = 1}^{K} \{ {log ( {V}_{dk} )}^{2} \}} ,$$
wherein \tilde{m}ₖ=mₖ−\hat{d}1, and mₖ is a vector of system output corresponding to the k^{th} training signal.

14. The method of claim 13, further comprising calculating a first error vector based at least in part on the second value, wherein the first error vector \hat{q} is found by the following:
$$\underline{\hat{q}} = \frac{2}{N \hat{g}} {( {\sum }_{k = 1}^{K} {S}_{k}^{2} )}^{- 1} ( {\sum }_{k = 1}^{K} {Ω}_{k} ) ,$$
wherein Ωₖ=SₖΘ^{T} \tilde{m}ₖ, Sₖ is a 4×4 matrix, diag(0.5,0.5, 1/V_{dk}, 1/V_{dk}), and Θ is an N×4 matrix, whose n^{th} row is [cos(2θₙ), sin(2θₙ), cos(θₙ), sin(θₙ)].

15. The method of claim 14, further comprising updating a compensation parameter vector q_{c}, wherein q_{c} is equal to the previous value of q_{c} minus \hat{q}, and q_{c}=[ε_{c} c_{c1} c_{c2}]^{T}, wherein εₚ is related to I and Q gains αₚ and βₚ according to:
$${α}_{p} = ( 1 + {ɛ}_{p} ) \sqrt{\frac{2}{2 + 2 {ɛ}_{p} + {ɛ}_{p}^{2}}} , and$$
$${β}_{p} = \sqrt{\frac{2}{2 + 2 {ɛ}_{p} + {ɛ}_{p}^{2}}} ,$$
φₚ is the I and Q phase imbalance, and cₚ₁, and cₚ₂ are I and Q offsets.

16. The method of claim 15, further comprising providing compensation parameters of the compensation parameter vector q_{c} to the quadrature modulation compensator, wherein the quadrature modulation compensator is configured to modify performance of the system based on the compensation parameters.

17. The method of claim 16, further comprising:
measuring a performance of the system modified by the quadrature modulation compensator; and
determining based at least in part on the performance whether the system is acceptably compensated.

18. The method of claim 17, further comprising:
providing a data signal to the quadrature modulation compensator; and
transmitting the data as part of a communication system.
